(19) United States
(12) Patent Application Publication
(10) Pub. No.: US 2007/0234207 A1
(43) Pub. Date: Oct. 4, 2007

(54) Method And Apparatus For Inserting And Removing Advertisements

(75) Inventor: Bhavin Turakhia, Mumbai (IN)

Correspondence Address: WELSH & KATZ, LTD, 120 S RIVERSIDE PLAZA, 22ND FLOOR, CHICAGO, IL, 60606, US

(73) Assignee: Directi Internet Solutions Private Limited, Mumbai (IN)

(21) Appl. No.: 11/696,366

(22) Filed: Apr. 4, 2007

(30) Foreign Application Priority Data
Apr. 4, 2006 (IN) 522/MUM/2006

(51) Int. Cl. G06F 17/00; G07G 1/14

(52) U.S. Cl. 715/530; 715/540; 705/14; 715/500

(57) ABSTRACT

The present invention relates to an apparatus and method of inserting any content, for instance commercial content and other dynamic or static content within the body of the original content and dynamically removing such commercial content based on a predefined action. For example, inserting and removing commercial content within IMAP and POP based email services within an email document, and in Web documents seen through a browser, without hampering the ability of a user to perform functions, such as print, forward etc that require the original document without the inserted commercial content.

### FIELD OF THE INVENTION

The invention relates generally to an automated process of insertion and removal of content within another content and specifically, to a method and apparatus for insertion and removal of commercial content within any form of content.

### BACKGROUND OF THE INVENTION

Traditional application or service providers who provide free software or services to clients could do so by displaying commercial content alongside an email or browser or any other application. However, the commercial content can only be inserted outside the content in a separate window or in case of an email, only in web based email services. Users who use Internet Message Access Protocol (“IMAP”) or Post Office Protocol (“POP3”) based email clients, generally download their emails within a local client computing device and read them within clients such as Outlook, Outlook Express, Thunderbird etc. Therefore free email service providers or providers of chat services such as various instant messengers or even browsers could not insert commercial content within the content the user is viewing due to the inability of the application or service provider to remove the commercial content from the original email content or HTML content.

Current methods of displaying commercial content involve showing the email in a web browser and alongside it in a separate frame or table, without modifying the contents of the original email or in a separate window. Hence there is a need to display commercial content to such users who download emails in an IMAP or POP client or view WebPages within the body of the content in such a manner that the commercial content can be removed when needed. Further, such an insertion must not affect the user experience. As an example, when such a user clicks the reply button in email, these advertisements must disappear. Hence there is a need for insertion and removal of advertisements and commercials within content which needs to be addressed.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

FIG. 1 illustrates a flow diagram of the commercial content insertion and removal process pursuant to an embodiment of the present invention.

FIG. 2 illustrates a flow diagram of the removal process of commercial content pursuant to an embodiment of the present invention.

FIG. 3 illustrates a block diagram of an embodiment of the present invention.

### DETAILED DESCRIPTION OF THE INVENTION

Before describing in detail embodiments that are in accordance with the invention, it should be observed that the embodiments reside primarily in combinations of method steps and apparatus components related to inserting and removing advertisements Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of inserting and removing advertisements described herein. The non-processor circuits may include, but are not limited to, a radio receiver, a radio transmitter, signal drivers, clock circuits, power source circuits, and user input devices. As such, these functions may be interpreted as steps of a method and system for inserting and removing advertisements. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention relates generally to providing commercial content in various forms in an unobtrusive fashion at a mail client in such a fashion that the recipient's functionality is not compromised. Those skilled in the art shall appreciate that commercial content can be any content that can either have a commercial value such as advertising content, or content that may lead a user to purchase a product or service or even content that can merely be informational in nature such as the weather of a city or stock quotes for the day or restaurants in places the user intends to visit or any such information. Further, those skilled in the art shall also appreciate that the present invention is not only restricted to email systems and may extend to webpages, chat programs and any other application that may enable the display of content. For instance, an internet service provider may display commercial content such as advertisements, weather metadata information, stock quotes etc. to a user browsing webpages using a browser. Alternatively, a chat client may use a similar plugin disclosed above to display commercial content to users of the chat client. Hence, the scope of the present invention may extend to any and all applications that can be capable of displaying content.

Insertion of commercial content allows e-mail service providers to offer free email services to users and generate revenue. These service providers display these advertisements and commercials in the browser in a web based email service. However, in conventional systems, when users of such email services use desktop email clients, for example, Outlook, Eudora, Outlook Express, Lotus Notes or any other email client using IMAP or POP3 protocols, email service providers are unable to display the advertisements and commercials to such users when they view their emails. One of the reasons due to which email service providers are unable to display commercial content within POP3, IMAP, etc. based email clients is the inability of conventional systems to remove the commercial content when the user wishes to forward the content, print the content, reply to the content, etc. These shortcomings of conventional systems extend to other applications such as inserting commercial content within the browser, chat and other such applications as well. For example, the inability to remove the commercial content inserted by a third party provider while printing a webpage.

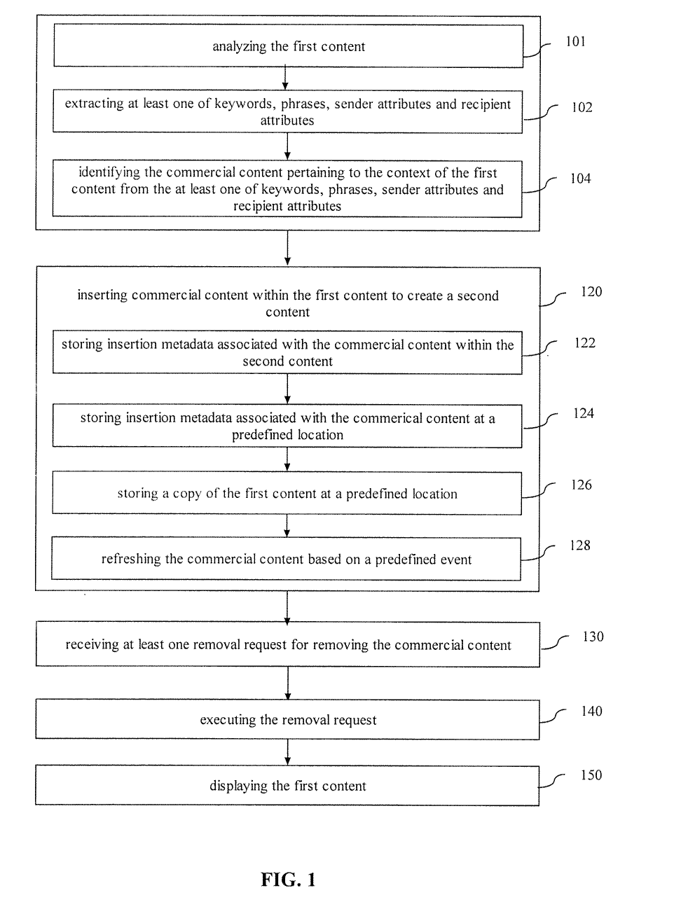

Turning now to FIG. 1 illustrates the insertion and removal process pursuant to an embodiment of the present invention. Those skilled in the art shall appreciate that although there may be several methods to insert commercial content within any form of content, all methods that store instructions for such removal of commercial content when a request is received from a user are within the scope of the present invention. An exemplary embodiment of insertion and removal of commercial content is disclosed below.

An embodiment of the present invention comprises a context analysis engine and a content insertion engine 300 to analyze the context of the first content, step 101 and then subsequently insert commercial content based on the analysis. The first content, as described above can be content prior to insertion of the commercial content. Those skilled in the art shall appreciate that commercial content can be any content that can either have a commercial value such as advertising content, or content that may lead a user to purchase a product or service or even content that can merely be informational in nature such as the weather of a city or stock quotes for the day or restaurants in places the user intends to visit or any such information. Hence, the first content is the original content free of any commercial content. The first content is modified to the second content on insertion of any commercial content. Now, consider a client, for instance a computing system that has been configured to receive IMAP/POP emails for example an email client application such as Eudora or Microsoft Outlook. The email client application may comprise a context analysis engine and a content insertion engine 300.

When a user sends an email using either a web-based mail client or a POP/IMAP based email-client to a recipient, the email is received by the context analysis engine prior to delivery at the client (recipient). Those skilled in the art shall appreciate that the email can be received directly by the client if the context analysis engine resides at the client or can be received by an external server if the context analysis engine resides on an external server (which could be the senders mail server, the recipients mail server or an intermediary server through which the email passes, or is made to pass) or alternatively the context analysis engine may also reside on the senders computing device.

The context analysis engine then performs the task of determining important topics within the email document, extracting keywords, phrases, advertisements and commercials that relate to the context of the email, step 102. The context analysis engine may fetch various attributes about the sender and the recipient such as their age, location, past behavior, and other pertinent metadata information from external sources such as the mail server/mail clients. The context analysis engine then determines the modifications to be made to the email document to display the relevant commercial content such as advertisements, keywords, phrases and to highlight important topics at specific positions within the email document. Metadata information about insertion and/or removal of such commercial content including expiry date of the commercial content, priority of each advertisement or commercial content, type of advertisement, type of content (such as related keyword, topic, phrase, others) and other such metadata information can also be determined or collected by the context analysis engine.

The context analysis engine may also determine based on the recipients preferences, as to whether various buttons such as a “Reply” button, a “Forward” button, a “Reply-all” button, a “Print” button and a “Clear Ads” button should be inserted within the first content, for example the email document. These buttons would allow a recipient who does not have a fully functional content insertion engine 300 installed within their email client or on their machine, to perform functions such as replying to an email by using the original clean, unmodified email without any advertisements or commercial content inserted within the first content. Those skilled in the art shall appreciate that any number of buttons can be provided and any combination of buttons can be provided based on the requirements.

In one embodiment, the context analysis engine may also store a flag with the insertion or removal instruction to determine as to whether the content insertion engine 300 can reverse this modification when the user clicks on a button such as “Reply”, “Reply-all”, “Forward” etc. The flag may also direct the content insertion engine 300 to not reverse some changes which do not need to be reversed or which the context analysis engine does not want the content insertion engine 300 to reverse. Reversing the modifications shall make the email document revert to the original formatting prior to sending.

All metadata information stored pertaining to the commercial content is considered to be metadata information. As per one embodiment, each insertion instruction can consist of a set of consecutive characters to be inserted within the email document along with the exact position where these characters are to be inserted, and each removal instruction consists of the exact position from where a set of consecutive characters need to be removed with the number of consecutive characters to be removed from the email document. Those skilled in the art shall appreciate that instead of consecutive characters, one may use consecutive words, lines and so on. Such metadata information is the metadata information for the first content which pertains to the insertion or removal or the commercial content from the second content.

As per another embodiment, the metadata information can consist of the characters to be inserted within the email document with one or more tags within the email body which identify the position where such insertion is to be made, and each removal instruction consists of a set of consecutive characters to be removed from the email document with one or more tags within the email body which identifies the position from where the characters maybe removed. The tags used maybe of such type that they are invisible when the email body is viewed in a normal viewer. For example in case of HTML documents, enclosing any content within “<” and “>” renders it invisible.

The advantage of encoding the insertion and removal instructions in the fashion described above is that the actual modifications can be performed by the content insertion engine 300, which can simply perform the modifications without getting into details of the actual modification itself. This abstracts the knowledge of the process used for modification of the email and of the insertion of advertisements, commercials and other content within the email and therefore allows one to change the rules for these modifications without having to update the content insertion engine 300 for any such changes. Since it is very likely for the content insertion engine 300 to be installed on the recipients machine as a part of his email client or as a plugin or independent program, therefore this method allows flexibility in changing the rules for modifying the email document, without the user having to download an update for the content insertion engine 300. However, those skilled in the art shall appreciate that the context analysis engine can also perform the tasks of the content insertion engine 300 described below.

In one embodiment, the context analysis engine then sends all the metadata information collected above to the content insertion engine 300. In another embodiment, the context analysis engine may also send instructions on how the content insertion engine 300 may communicate with the context analysis engine if it wants to refresh the advertisements, commercials and content within the email document. For instance, by making a call to a Uniform Resource Locator (URL) on a server which can return the required data. As per one embodiment all this above metadata information maybe inserted within the header portion of the email document from where the content insertion engine 300 may extract it when required. As per another embodiment the same maybe inserted at one or more portions within the body of the email demarcated using special tags that can be used to identify such metadata information. As per another embodiment, this metadata information maybe stored separately on the recipients machine, or another machine or server, with an identifier that identifies the email document that the metadata information is associated with and the content insertion engine 300 maybe instructed to fetch the same from there. As per another embodiment, the context analysis engine may itself perform the tasks of identifying and inserting commercial content based on the analysis of keywords, phrases, sender and recipient attributes of the first content that can be performed by the content insertion engine 300, step 104. As per another embodiment, this metadata information maybe passed to the content insertion engine 300 by using a network communication protocol, or if the content insertion engine 300 and context analysis engine are running on the same machine, or are both modules within the same program, this metadata information maybe passed to the content insertion engine 300 by using some other protocol such as shared memory variables etc.

Prior to reaching the recipient, the email passes through the content insertion engine 300 to insert the commercial content within the first content to create the second content, step 120. The task of the content insertion engine 300 is to modify the email as per metadata information passed to the content insertion engine 300 by the context analysis engine, as well as to reverse those modifications when required, such as when the recipient wants to reply to the email and so on. The reversal of modifications can also be performed using metadata information stored during the insertion of the commercial content. As per one embodiment, the content insertion engine 300 receives this metadata information from the context analysis engine within the email itself, step 122, and proceeds to extract the same from within the email body or header. As per another embodiment the content insertion engine 300 maybe instructed to fetch metadata information gathered by the context analysis engine from a separate predefined location such as storage area on the same machine, or an external server, or by contacting the context analysis engine, step 124. In another embodiment, the content insertion engine may store a copy of the first content at a predefined location for retrieval later, step 126.

The content insertion engine 300 then performs modification tasks based on the metadata information obtained such as insertion of keywords, advertisements, commercials, insertion of a search box, highlighting of topics, insertion of buttons for reply, forward etc. These keywords, topics and search box may link to online web pages which contain advertisements. The content insertion engine 300 may also check if any advertisement or content it is about to insert has expired, and may communicate with the context analysis engine, or any other program as provided for in the instructions of the context analysis engine, to fetch a fresh set of advertisements or content in place of that which has expired. The advertisements and commercials can be obtained dynamically in all embodiments.

When the user views any email, the second content, which is the first content with the commercial content is shown to the user. The content insertion engine 300 may ensure that the email document that the user views is the second content. The content insertion engine 300 may also refresh the advertisements, step 128, commercials and any other content within the modified email copy based on the expiry metadata information associated with the content as inserted by the context analysis engine, and based on the internal configuration of the content insertion engine 300 which may store settings with regards to how frequently the content insertion engine 300 should refresh advertisements. The content insertion engine 300 may also refresh the advertisements, commercials, other content based on user behavior. For instance if an advertisement has already been displayed to a user one or more times and the user has not shown interest in the advertisement then it may make sense to replace it. Similarly if an advertisement has been shown to the user and the user has already clicked on the same, then it is likely that the user will not click on it again and therefore it may make sense to replace that advertisement. Similar rules may apply to other content, such as news items or any other content that maybe inserted within the email.

Upon refreshing such content, the content insertion engine 300 will make changes to the metadata information that the context analysis engine passed to it, so that subsequent modifications of that email use the new refreshed metadata information. Since the content insertion engine 300 reverses modifications made by it, after the recipient clicks on reply, forward or a similar function that requires a clean copy of the email, as described in detail later in this document, it may occur that the email does not contain advertisements, commercials and other content that it should. In this case, when the user views the email once again, at anytime, for the purpose of solely viewing it, the content insertion engine 300 must once again perform the necessary modifications to the email. In one embodiment the content insertion engine 300 once again performs the steps described above for obtaining a modified copy of the email. In another embodiment if the content insertion engine 300 has performed the modifications once, it may store the modified copy of the email in some folder or database or memory or within the email document itself, so that it may access it when it needs to display the modified copy of the email.

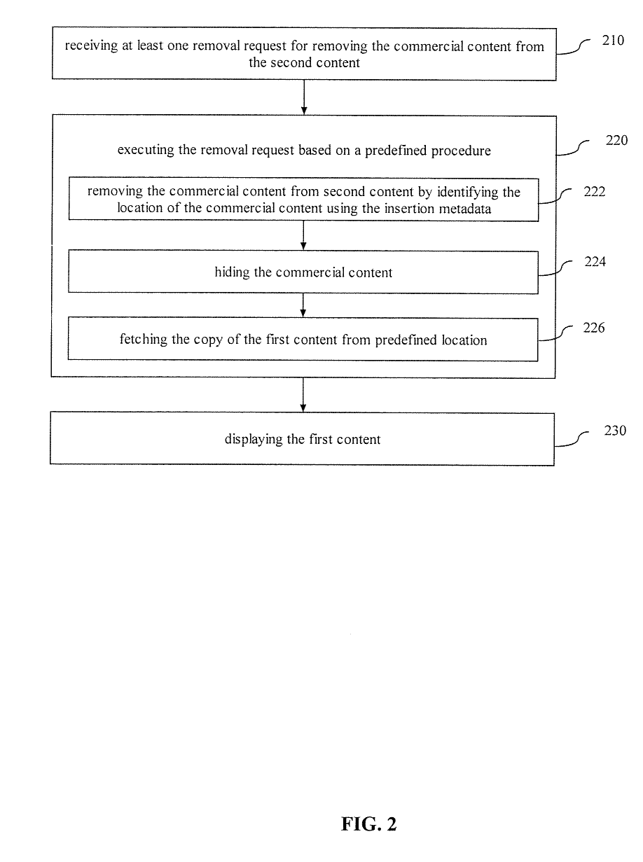

Now, when the user wishes to revert to the first content, for example while replying to the email or printing the email, the user sends a request for removing the commercial content from the second content, step 130. The request is executed based on a predefined procedure disclosed in detail using FIG. 2, step 140 and the first content is subsequently displayed, step 150. For example, if a user clicks on a reply button within an email client such as Microsoft Outlook, an embodiment of the present invention, executes a request to remove the commercial content inserted within the first content and then displays the email as the first content to the user. The content insertion engine 300 must reverse all modifications made to the first content to create the second content. Similarly when a user prints the email, the printed copy should not contain the commercial content, and so on.

Turning now to FIG. 2 illustrates a method using which the content inserted can be removed pursuant to one embodiment of the present invention. To further illustrate the invention, we can assume an email service provider as an exemplary embodiment of the present invention.

As disclosed in FIG. 1, when a user sends an email, the email can be received by a context analysis engine that can be responsible for analyzing the first content. The first content can be the original content sent by the sender that is free of any commercial content inserted by any third party. Those skilled in the art shall appreciate that commercial content can be any content that can either have a commercial value such as advertising content, or content that may lead a user to purchase a product or service or even content that can merely be informational in nature such as the weather of a city or stock quotes for the day or restaurants in places the user intends to visit or any such information. The second content is created by inserting commercial content within the first content. The context analysis engine then performs the task of determining important topics within the email document, identifying keywords, phrases, advertisements and commercials that relate to the context of the email as well as relate to other attributes such as attributes about the sender and recipient, and then determines the modifications to be made to the email document to display the relevant advertisements, keywords, phrases and other commercial content and to highlight important topics at specific positions within the email document.

The context analysis engine can then insert the commercial content and metadata information pertaining to the commercial content within the first content based on the analysis performed. The insertion of metadata information, which comprises information pertaining the insertion of commercial content as well as removal instructions for the commercial content has been disclosed using FIG. 1. For example, metadata information can comprise at least one of a location of the commercial content within the second content, the number of characters of the commercial content, the size of the commercial content, the position of the commercial content, predefined identifiers and predefined delimiters used to identify the location of the commercial content within the second content. As per another embodiment the insertion of metadata information and commercial content within the first content can be performed by a content insertion module residing on a separate computing system which is in communication with the context analysis engine to receive the analysis. In another embodiment, the context analysis engine and the content insertion engine 300 can be a part of a single computing system. Insertion metadata can comprise at least one of a location of the commercial content within the second content, the number of characters of the commercial content, the size of the commercial content, the position of the commercial content, predefined identifiers and predefined delimiters used to identify the location of the commercial content within the second content and so on.

Now, when the user wishes to revert to the first content, for example while replying to the email or printing the email, the user sends a request for removing the commercial content from the second content, step 210. The request is executed based on a predefined procedure, step 220 and the first content is subsequently displayed, step 130. For example, if a user clicks on a reply button within an email client such as Microsoft Outlook, an embodiment of the present invention executes a request to remove the commercial content inserted within the first content and then displays the email as the first content to the user. The content insertion engine 300 must reverse all modifications made to the first content to create the second content. Similarly when a user prints the email, the printed copy should not contain the commercial content, and so on.

The removal of commercial content can be performed using several methods. As per one embodiment the content insertion engine 300 may, while making modifications to the email document, store metadata information of those insertions of commercial content within the email header, or email body, or memory, step 222. The content insertion engine 300 may also store metadata information for reversing those modifications. This metadata information can be the exact opposite of the metadata information that it uses to make the modifications in the first place. For example, insertion metadata can comprise at least one of a location of the commercial content within the second content, the number of characters of the commercial content, the size of the commercial content, the position of the commercial content, predefined identifiers and predefined delimiters used to identify the location of the commercial content within the second content and so on. When required to reverse its modifications and display a clean copy of the email, the content insertion engine 300 simply processes these reversal instructions to obtain a clean copy of the email.

As per another embodiment the content insertion engine 300 may, fetch a clean copy of the email document from some server or memory store where it has been stored by the context analysis engine or some other program, prior to modification, step 226. As per another embodiment to reverse its modifications, the content insertion engine 300 may simply hide the modifications by using tags that would hide modifications and render them invisible to a user. As per another embodiment the content insertion engine 300 may, prior to making any modifications to the first content (original copy of the content), store a clean copy of the email document in some folder or database or memory or within the email document itself. When required to reverse its modifications and display a clean copy of the email, it simply swaps the modified email copy with a clean email copy.

As per another embodiment, the removal request comprises hiding the commercial content to display the first content, step 226. For instance the metadata information can consist of the characters that are inserted within the email document with one or more tags within the email body which identify the position where such insertion is to be made, and each removal instruction consists of a set of consecutive characters to be removed from the email document with one or more tags within the email body which identifies the position from where the characters maybe removed. The tags used maybe of such type that they are invisible when the email body is viewed in a normal viewer. For example in case of HTML documents, enclosing any content within “<” and “>” renders it invisible. Hence all commercial content inserted in text can be encapsulated by “<” and “>” rendering the text invisible. Alternatively, the metadata information can provide information pertaining to number of characters that are to be deleted per line or per location. Further, the text can be made transparent or changed to the color of the background to render the commercial content invisible. Those skilled in the art shall appreciate that methods of hiding can be differ based on the nature of the script (Javascript, HTML, XML etc.) and the nature of the content used and all such methods are within the scope of the present invention.

In an alternate embodiment, the content insertion engine's 300 behavior may also be controlled through a configuration file maintained on the same machine or in some database or memory. This configuration file may contain various different settings that dictate how the content insertion engine 300 performs various tasks. For instance, the configuration file may dictate the method and provide metadata information that the content insertion engine 300 uses to modify an email and reverse the modifications, for example whether the content insertion engine 300 must store a clean copy of the email, or simple instructions for reversing the modifications.

Generally, the request to remove commercial content from the first content can be a user initiated action from within the second content or by an action performed by the user from within the application itself. For instance, the content insertion engine 300 may have inserted “Reply”, “Reply-all”, “Forward”, “Print”, “Clear Ads” and other such buttons or links within the email itself. The user is instructed to click on these buttons or a hyperlink within the second content when he wishes to perform any of these functions.

In another embodiment where the content insertion engine 300 is a plug-in within the email client, it may provide a separate toolbar, or buttons such as “Reply”, “Forward” etc within the email client. The user is instructed to perform the action of clicking on these buttons when he wishes to perform any of these functions, as opposed to clicking on the corresponding buttons within the second content. In another embodiment where the content insertion engine 300 is a part of the email client, it may hook into the email client, and when the user clicks on buttons such as “Reply”, “Forward” etc within the email client, the content insertion engine 300 may intercept such an event and initiate the removal request process.

In each of the three scenarios disclosed above, the user clicking a button either within the email client, or within the plug-in, or within the email itself, can invoke a clean copy of the email which then is displayed to the user, within his email client, for such purpose. Alternatively the click may popup a separate application window which allows the user to perform these functions using a clean copy of the email. Alternatively the click may popup a browser window which may fetch a clean copy of the email from the local store or a server and allow the user to perform these functions. Alternatively the click may log the user into his web based email interface, which may allow the user to reply to the email using a clean copy of the email.

Those skilled in the art shall appreciate that the present invention is not only restricted to email systems and may extend to webpages, chat programs and any other application that may enable the display of any content. For instance, an internet service provider may display commercial content such as advertisements, weather metadata information, stock quotes etc. to a user browsing webpages using a browser, and when the user requires to print the page, a similar content insertion engine 300 may perform the necessary reversals. Alternatively, a chat client may use a similar plugin disclosed above to display commercial content to users of the chat client. Hence, the scope of the present invention may extend to any and all applications that may require the display of content that has been modified to include commercial content within the first content and then having a need to remove the commercial content to obtain the first content. The present invention is able to offer free IMAP and POP based email services by inserting advertisements and commercials within the email document, yet at the same time, allowing users to reply to or forward the email or perform any functions that require a clean email copy without inconvenience.

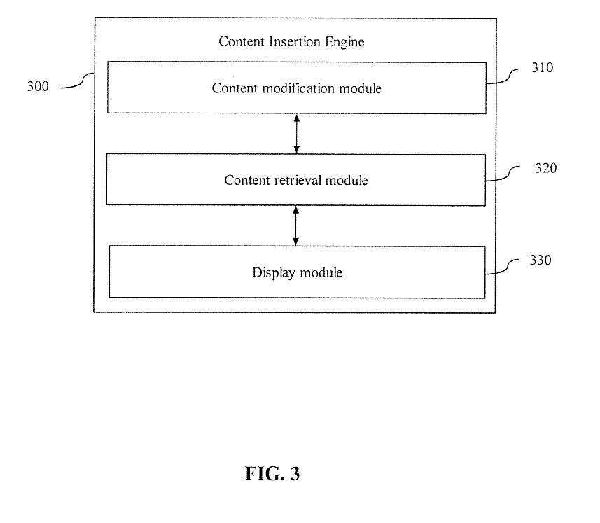

Turning now to FIG. 3 illustrates a system diagram of an embodiment of the present invention. The email client application may comprise a context analysis engine and a content insertion engine 300 installed as a plug-in from a third party performing the functions disclosed below or have the functionality built into the email client. In another embodiment, the context analysis engine may reside on a server and a content insertion engine 300 maybe installed within the email client as a plug-in from a third party performing the functions disclosed below or have the functionality of the ad-engine built into the email client. In another embodiment the context analysis engine and content insertion engine 300 can reside as independent programs on the sender and/or recipient's computing system through which the email is sent or received. In another embodiment, the context analysis engine and the content insertion engine 300 can reside on a separate server. In another embodiment the context analysis engine and content insertion engine 300 may reside both on the server as well as within the sender and/or recipient's machine either as independent programs or as a plug-in into the email client or as a part of the email client. In another embodiment one or more copies of the context analysis engine and content insertion engine 300 may run on one or more servers and/or on the sender's machine and/or on the recipient's machine, each of which may perform all or some of the functions disclosed in the present invention. Those skilled in the art shall appreciate that both the content insertion engine 300 and the context analysis engine maybe implemented as a single integrated application or two separate applications or even more than two applications that provide the functionality described in this document.

The content insertion engine 300 comprises a content modification module 310 to insert the commercial content within the first content to create the second content, a content retrieval module 320 to execute a removal request for removing the commercial content from the second content based on a predefined procedure and a display module 330 to display the first content. As per one embodiment, the content modification module, the content retrieval module and the display module are a part of a single module. The content modification module, the content retrieval module and the display module can reside on can separate servers, the content modification module, the content retrieval module and the display module being in communication with each other. In an alternate embodiment, the content modification module, the content retrieval module and the display module can be a part of a third party application such as an email client, a chant client and an internet browser.

What is claimed is:

1. A method of displaying a first content from a second content, the first content being modified to a second content by inserting commercial content, the method comprising:
inserting commercial content within the first content to create the second content;
receiving at least one removal request for removing the commercial content from the second content; and
executing the removal request based on a predefined procedure; and
displaying the first content.

2. The method of claim 1, wherein the step of inserting commercial content further comprises:
analyzing the first content;
selecting the commercial content based on the analysis of the first content.

3. The method of claim 1, wherein the step of inserting commercial content further comprises:
analyzing the first content;
extracting information from the first content; and
identifying the commercial content based on the extracted information.

4. The method of claim 3, wherein the extracted information comprises keywords.

5. The method of claim 3, wherein the extracted information comprises phrases.

6. The method of claim 3, wherein the extracted information comprises sender attributes.

7. The method of claim 3, wherein the extracted information comprises recipient attributes.

8. The method of claim 1, wherein the step of inserting commercial content further comprises:
storing insertion metadata associated with the commercial content within the second content;
storing insertion metadata associated with the commercial content at a predefined location;
storing a copy of the first content at a predefined location; and
refreshing the commercial content based on a predefined event.

9. The method of claim 8, wherein the insertion metadata comprises a location of the commercial content within the second content.

10. The method of claim 8, wherein the insertion metadata comprises the number of characters of the commercial content,

11. The method of claim 8, wherein the insertion metadata comprises the size of the commercial content.

12. The method of claim 8, wherein the insertion metadata comprises the position of the commercial content.

13. The method of claim 8, wherein the insertion metadata comprises predefined identifiers and predefined delimiters used to identify the location of the commercial content within the second content.

14. The method of claim 8, wherein the predefined procedure in the step of executing the removal request further comprises removing the commercial content from the second content by identifying the location of the commercial content using the insertion metadata.

15. The method of claim 8, wherein the predefined procedure in the step of executing the removal request further comprises hiding the commercial content.

16. The method of claim 8, wherein the predefined procedure in the step of executing the removal request further comprises fetching the copy of the first content from a predefined location.

17. A method for removing a commercial content from a second content, the second content being created by the commercial content having been inserted in a first content, the method comprising:
receiving at least one removal request for removing the commercial content from the second content; and
executing the removal request based on a predefined procedure; and
displaying the first content.

18. The method of claim 17, wherein executing the removal request is performed using a user initiated action from within the second content, the user initiated action being a click on a hyperlink for removal of commercial content.

19. The method of claim 17, wherein executing the removal request is performed using an action performed from within an application, the action being a click on a button.

20. The method of claim 17, wherein the first content is displayed in a separate application window comprising an internet browser window or a popup window.

21. The method of claim 17, wherein the first content is an electronic mail content.

22. The method of claim 17, wherein the first content is a chat content.

23. The method of claim 17, wherein the first content is a webpage content.

24. The method of claim 17, wherein, the removal request comprises of a user initiated action to print the first content.

25. The method of claim 17, wherein the first content is electronic mail content, and the removal request comprises a user initiated action to reply to the electronic mail content.

26. The method of claim 17, wherein the first content is electronic mail content, and the removal request comprises a user initiated action to reply to forward the electronic mail content.

27. A system for removing a commercial content from a second content, the second content being created by inserting the commercial content in a first content, the system comprising:
a content modification module to insert the commercial content within the first content to create the second content;
a content retrieval module to execute a removal request for removing the commercial content from the second content based on a predefined procedure; and
a display module to display the first content.

28. The system of claim 27, wherein the content modification module is configured to store insertion metadata associated with the commercial content within the content.

29. The system of claim 27, wherein the content modification module is configured to store insertion metadata associated with the commercial content at a predefined location.

30. The system of claim 27, wherein the content modification module is configured to store a copy of the first content at a predefined location.

31. The system of claim 27, wherein the content modification module is configured to refresh the commercial content based on a predefined event.

32. The method of claim 27, wherein the system is configured to store insertion metadata, the insertion metadata further comprising a location of the commercial content within the second content.

33. The method of claim 27, wherein the system is configured to store insertion metadata, the insertion metadata further comprising the number of characters of the commercial content.

34. The method of claim 27, wherein the system is configured to store insertion metadata, the insertion metadata further comprising the size of the commercial content.

35. The method of claim 27, wherein the system is configured to store insertion metadata, the insertion metadata further comprising the position of the commercial content.

36. The method of claim 27, wherein the system is configured to store insertion metadata, the insertion metadata further comprising predefined identifiers and predefined delimiters used to identify the location of the commercial content within the second content.

37. The system of claim 27, wherein the content retrieval module is configured to remove the commercial content from the second content by identifying the location of the commercial content using the insertion metadata.

38. The system of claim 27, wherein the content retrieval module is configured to hide the commercial content.

39. The system of claim 27, wherein the content retrieval module is configured to fetch the copy of the first content from a predefined location.

40. The system of claim 27, wherein the content modification module, the content retrieval module and the display module are a part of a single module.

41. The system of claim 27, wherein at least one of the content modification module, the content retrieval module and the display module can reside on can separate servers, the content modification module, the content retrieval module and the display module being in communication with each other.

42. The system of claim 27, wherein at least one of the content modification module, the content retrieval module and the display module are a part of a third party application.

43. The system of claim 42, wherein the third party application is at least one of an email client, a chant client and an internet browser.
